(19) United States
(12) Patent Application Publication
(10) Pub. No.: US 2021/0362732 A1
(43) Pub. Date: Nov. 25, 2021

(54) INFORMATION PROCESSING APPARATUS AND METHOD

(71) Applicant: TOYOTA JIDOSHA KABUSHIKI KAISHA, Toyota-shi (JP)

(72) Inventors: Shin SAKURADA, Toyota-shi (JP); Kazuya NISHIMURA, Toyota-shi (JP); Masaru ANDO, Seto-shi (JP); Toshinari HONDA, Anjo-shi (JP)

(73) Assignee: TOYOTA JIDOSHA KABUSHIKI KAISHA, Toyota-shi (JP)

(21) Appl. No.: 17/326,751

(22) Filed: May 21, 2021

(30) Foreign Application Priority Data
May 25, 2020 (JP) 2020-090856

(51) Int. Cl. B60W 50/00; G06Q 10/06; G07C 5/00; G06F 21/78; B60R 11/04; G01C 21/36

(52) U.S. Cl. CPC B60W 50/0098; G06Q 10/06312; G07C 5/008; G07B 15/063; B60R 11/04; G01C 21/3626; G06F 21/78

(57) ABSTRACT

An information processing apparatus includes a controller configured to acquire, in relation to a first vehicle associated with a predetermined organization, information about a schedule including a purpose of use, output, in a case where the purpose of use of the first vehicle is business activity, first use-settings information indicating settings regarding use of one or more options mounted in the first vehicle, and output, in a case where the purpose of use of the first vehicle is personal use, second use-settings information indicating settings regarding use of the one or more options mounted in the first vehicle.

### CROSS REFERENCE TO THE RELATED APPLICATION

This application claims the benefit of Japanese Patent Application No. 2020-090856, filed on May 25, 2020, which is hereby incorporated by reference herein in its entirety.

### BACKGROUND

### Technical Field

The present disclosure relates to an information processing apparatus and a method.

### Description of the Related Art

There is disclosed a company/employee car sharing system for enabling car-sharing between a company and an employee, according to which a company rents out a company vehicle to an employee for personal use (for example, Japanese Patent Laid-Open No. 2019-061575).

An object of the present disclosure is to provide an information processing apparatus and a method that enable use settings for options mounted in a vehicle to be changed according to purpose of use.

### SUMMARY

One aspect of the present disclosure is an information processing apparatus comprising a controller configured to:

acquire, in relation to a first vehicle associated with a predetermined organization, information about a schedule including a purpose of use,

output, in a case where the purpose of use of the first vehicle is business activity, first use-settings information indicating settings regarding use of one or more options mounted in the first vehicle, and

output, in a case where the purpose of use of the first vehicle is personal use, second use-settings information indicating settings regarding use of the one or more options mounted in the first vehicle.

Another aspect of the present disclosure is a method comprising:

acquiring, in relation to a first vehicle associated with a predetermined organization, information about a schedule including a purpose of use,

outputting, in a case where the purpose of use of the first vehicle is business activity, first use-settings information indicating settings regarding use of one or more options mounted is the first vehicle, and

outputting, in a case where the purpose of use of the first vehicle is personal use, second use-settings information indicating settings regarding use of the one or more options mounted in the first vehicle.

According to the present disclosure, use settings for options mounted is a vehicle may be changed according to the purpose of use.

### BRIEF DESCRIPTION OF THE DRAWINGS

FIG. 1 is a diagram illustrating an example of a system configuration of a company vehicle rental system according to a first embodiment;

FIG. 2 is an example of a hardware configuration of the center server;

FIG. 3 is a diagram illustrating an example of a hardware configuration of the company vehicle;

FIG. 4 is a diagram illustrating an example of a functional configuration of the center server;

FIG. 5 is an example of a vehicle information table;

FIG. 6 is an example of an option-use-settings information table for when the purpose of use is business activity;

FIG. 7 is an example of the option-use-settings information table for when the purpose of use is personal use;

FIG. 8 is an example of the data structure of the schedule information database; and

FIG. 9 is an example of a flowchart of a settings management process by the center server.

### DESCRIPTION OF THE EMBODIMENTS

For example, in relation to use of a company vehicle that is rented out for personal use, there are concerns that a place that one privately visited or a private conversation inside the vehicle becomes known to a third party, and there are demands that recording of sound inside the vehicle and recording of images of surroundings of the vehicle not be performed by a dashboard camera. Accordingly, in the case of renting out a company vehicle for personal use, requirements regarding settings of use of options are different from those in the case of use for business activity.

One aspect of the present disclosure is an information processing apparatus including a controller. The information processing apparatus may be a server, for example. However, the information processing apparatus is not limited to a server, and may alternatively be an onboard device that is mounted is a vehicle. The controller may be a processor such as a central processing unit (CPU), for example. According to an aspect of the present disclosure, the controller may acquire, in relation to a first vehicle associated with a predetermined organization, information about a schedule including a purpose of use. Furthermore, the controller may output, is a case where the purpose of use of the first vehicle is business activity, first use-settings information indicating settings regarding use of one or more options mounted in the first vehicle. The controller may output, in a case where the purpose of use of the first vehicle is personal use, second use-settings information indicating settings regarding use of the one or more options mounted in the first vehicle.

The predetermined organization may be a company, a public office, a local authority or the like, for example. The first vehicle that is associated with the predetermined organization may be a vehicle that is owned by the predetermined organization, or a vehicle that the predetermined organization is leasing from another organization, for example. The first vehicle that is associated with the predetermined organization may be a vehicle that is referred to as a company vehicle, a government vehicle, or a business vehicle, for example. Personal use of the first vehicle may include, in addition to a private use of the vehicle, a preliminary or preparatory use that is a part of the activity of the organization but that is not the use according to the original purpose of using the vehicle, such as simply moving the vehicle between hubs of the organization (relocation of the vehicle).

Options mounted in the vehicle may be devices not related to a travel function of the vehicle. Options mounted in the vehicle may include a car navigation system, a dashboard camera, as electronic toll collection (ETC) onboard device and an ETC card, an audio system and the like, for example. Additionally, options mounted in the vehicle are not limited to the above, and may include, in a case where the vehicle is a camping car, for example, a television, a refrigerator, a kitchen stove and the like. Use-settings information of as option includes information about usability/non-usability, restrictions on a function that can be used, and the like, for example.

According to one aspect of the present disclosure, use settings of options mounted in the first vehicle are changed depending on whether the purpose of use of the first vehicle is business activity or personal use. Privacy of a user may thus be protected in a case of personal use of the first vehicle. Furthermore, restrictions may be also imposed on use at the time of personal use of the first vehicle.

In one aspect of the present disclosure, in a case where a time that is a predetermined time before a start time of a schedule is reached, the controller may output the use-settings information of the options of the first vehicle to the first vehicle. The first vehicle may thus be smoothly used at the time of start of the schedule.

In one aspect of the present disclosure, the first use-settings information may indicate that all of a plurality of options are usable, and the second use-settings information may indicate that use of at least one of the plurality of options is restricted. In this case, the first use-settings information may include enabling an ETC card that is inserted in the ETC onboard device. The second use-settings information may include disabling the ETC card. Personal use of an ETC card mounted in the first vehicle may thus be prevented.

Furthermore, the first use-settings information may include, is relation to the dashboard camera, recording a captured image of surroundings of the first vehicle. The second use-settings information may include, in relation to the dashboard camera, not recording the captured image of the surroundings of the first vehicle. Video data for the inside of the vehicle may thus be Prevented from being seen by a third party in the case of a personal use.

Furthermore, the first use-settings information may include, in relation to the dashboard camera, recording sound inside the first vehicle. The second use-settings information may include, in relation to the dashboard camera, not recording the sound inside the first vehicle. A conversation inside the vehicle may thus be prevented from being heard by a third party in the case of a personal use outside business activity.

Furthermore, the first use-settings information may include, in relation to the dashboard camera, saving, in a first storage, data of a captured image of surroundings of the first vehicle that is recorded or data of sound inside the first vehicle that is recorded. The second use-settings information may include, in relation to the dashboard camera, saving, in a second storage, data of a captured image of surroundings of the first vehicle that is recorded or data of sound inside the first vehicle that is recorded. Furthermore, in this case, the second storage may be protected by a password that is notified to a user of the first vehicle. The first storage and the second storage are each a main memory or a storage medium that is mounted in the dashboard camera, or a storage area in the main memory or the storage medium, for example. By saving data that is acquired by the dashboard camera in a different area depending on the purpose of use, data that is recorded at the time of personal use may be prevented from being easily accessed by a third party.

Furthermore, the first use-settings information may include, in relation to the car navigation system, setting an address that is associated with the predetermined organization as home information. The second use-settings information may include, in relation to the car navigation system, setting an address that is associated with a user of the first vehicle as the home information. The burden on the user of the first vehicle of having to set the home information for car navigation may thus be eliminated.

In the following, an embodiment of the present disclosure will be described with reference to the drawings. The configuration of the embodiment described below is an example, and the present disclosure is not limited to the configuration of the embodiment.

### First Embodiment

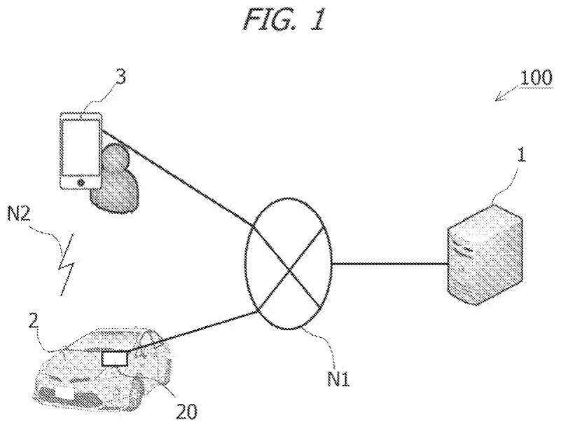

FIG. 1 is a diagram illustrating an example of a system configuration of a company vehicle rental system. 100 according to a first embodiment. The company vehicle rental system 100 is a system for renting out a company vehicle of one company to employees and general users. A company vehicle is a vehicle that is owned or leased by a predetermined company, for example. A general user is a user who does not belong to a company that is associated with the company vehicle, for example. Additionally, an organization that can use the company vehicle rental system 100 is not limited to a company, and may be an organization such as a public office or a local authority.

The company vehicle rental system 100 includes a center server 1, a company vehicle 2, and a user terminal 3. FIG. 1 illustrates one company vehicle 2 and one user terminal 3 for the sake of convenience, but a plurality of company vehicles 2 and a plurality of user terminals 3 are actually included. A data communication device 20 that communicates with the center server 1 is mounted in the company vehicle 2. The user terminal 3 is a terminal of an employee of the company using the company vehicle rental system 100 or a general user, and a client application program for receiving a service of the company vehicle rental system 100 is installed therein. The center server 1 is an example of “information processing apparatus”.

The center server 1, the data communication device 20, and the user terminal 3 are connected to a network N1 that is a public network such as the Internet. The data communication device 20 and the user terminal 3 are each capable of communicating with the center server 1.

The company vehicle 2 is managed by a predetermined organization. A plurality of options are mounted in the company vehicle 2. The options mounted in the company vehicle 2 include a car navigation system, a dashboard camera, and an ETC onboard device and an ETC card, for example. However, the options mounted in the company vehicle 2 are not limited to those listed above.

A user transmits a rental request for the company vehicle from the user terminal 3 to the center server 1 through the client application program. User identification information, the purpose of use, and search conditions including a rental period, a departure point and a return point are also transmitted together with the rental request. The purpose of use may be a business activity or a personal use, for example.

When the rental request is received from the user terminal 3, the center server I extracts the company vehicle 2 that matches the search conditions, and transmits information about the extracted company vehicle 2 to the user terminal 3. The user terminal 3 displays the information about the company vehicle 2 matching the search conditions, and transmits, to the center server a reservation request for the company vehicle 2 that is selected by a user operation. The center server 1 receives the reservation request from the user terminal 3, registers a schedule for the selected company vehicle 2, and fixes the reservation.

For example, when a time that is a predetermined time before a start time of the schedule is reached, the center server 1 transmits, to the data communication device 20, first use-settings information or second use-settings information about use of options mounted in the company vehicle 2, depending on whether the purpose of use of the company vehicle 2 is business activity or personal use. The data communication device 20 performs setting regarding use of the options according to the first or the second use-settings information received from the center server 1.

The first use-settings information is use-settings information for when the purpose of use is business activity. The second use-settings information is use-settings information for when the purpose of use is personal use. For example, the first use-settings information indicates that all the functions are usable in relation to the options mounted in the company vehicle 2. For example, the second use-settings information indicates that use of some or all of the functions is restricted in relation to the options mounted in the company vehicle 2.

According to the first embodiment, settings information about use of the options mounted in the company vehicle 2 is changed depending on whether the purpose of use of the company vehicle 2 is business activity or personal use. Usable functions of the options are thus automatically made different depending on the purpose of use of the company vehicle 2.

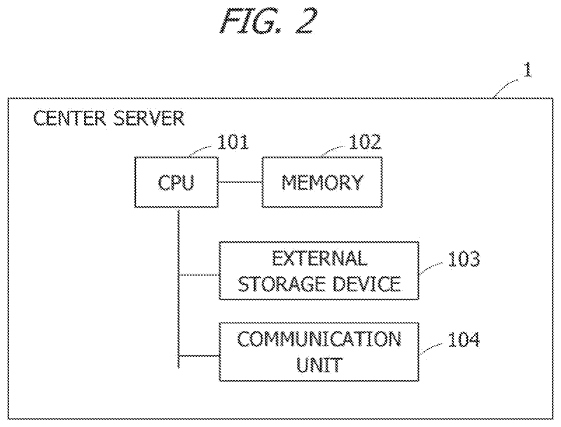

FIG. 2 is an example of a hardware configuration of the center server 1 As the hardware configuration, the center server 1 includes a CPU 101, a memory 102, as external storage device 103, and a communication unit 104. The memory 102 and the external storage device 103 are each a computer-readable recording medium. The center server 1 is an example of “information processing apparatus”.

The external storage device 103 stores various programs, and data to be used by the CPU 101 at the time of execution of each program. For example, the external storage device 103 is an erasable programmable ROM (EPROM) or a hard disk drive. Programs to be held in the external storage device 103 include an operating system (OS), a control program of the company vehicle rental system 100, and various other application programs, for example.

The memory 102 is a main memory that provides, to the CPU 101, a storage area for loading programs stored in the external storage device 103 and a work area, and that is used as a buffer. The memory 102 includes semiconductor memories such as a read only memory (ROM) and a random access memory (RAM), for example.

The CPU 101 performs various processes by loading the OS and various application programs held in the external storage device 103 into the memory 102 and executing the same. The number of CPUs 101 is not limited to one, and a plurality of CPUs may be provided. The CPU 101 is an example of “controller”.

The communication unit 104 is a wired network card such as for a local area network (LAN) or a dedicated line, for example, and the communication unit 104 connects to a public network such as the Internet over an access network such as the LAN. The hardware configuration of the center server 1 is not limited to the one illustrated in FIG. 2.

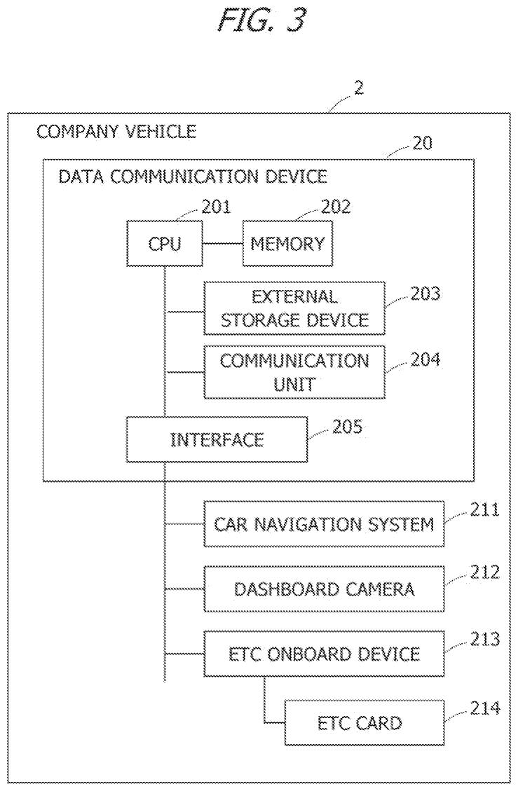

FIG. 3 is a diagram illustrating as example of a hardware configuration of the company vehicle 2. FIG. 3 extracts and illustrates hardware structural elements of the company vehicle 2 related to processes by the company vehicle rental system 100. The company vehicle 2 includes the data communication device 20, a car navigation system 211, a dashboard camera 212, and an ETC onboard device 213.

The data communication device 20 includes a CPU 201, a memory 202, an external storage device 203, a communication unit 204, and an interface 205. The CPU 201, the memory 202, and the external storage device 203 are the same as the CPU 101, the memory 102, and the external storage device 103. An OS, a control program of the company vehicle rental system 100 for the company vehicle 2, and various other application programs are stored in the external storage device 203 of the data communication device 20, for example.

The communication unit 204 is an interface through which information is input/output from/to a network. The communication unit 204 is an interface that connects to a wireless network. For example, the communication unit 204 performs 5th generation (5G), long term evolution (ITE) or 3rd generation (3G) mobile communication, or communication according to a wireless communication standard such as WiFi.

The interface 205 is an interface for connection between the data communication device 20 and other hardware structural elements. For example, the interface 205 connects to a controller area network (CAN).

The car navigation system 211, the dashboard camera 212, and the ETC onboard device 213 each include a processor, a memory, an external storage device, and a communication unit. For example, the car navigation system 211 is capable of storing in advance information about a location that is frequently used, such as home or a workplace. The dashboard camera 212 records captured images from a camera that is installed on the company vehicle 2 in a manner facing outside in a forward and/or rearward direction, and/or records sound outside and Inside the company vehicle 2. Video data that is recorded by the dashboard camera 212 is recorded in the external storage device of the dashboard camera 212.

An ETC card 214 is inserted in the ETC onboard device 213. In the first embodiment, the ETC card 214 is a card that is managed by the organization managing the company vehicle 2. At the time of passing through an ETC lane of a toll road, the ETC onboard device 213 reads information recorded in an IC chip in the ETC card 214, transmits the information to a roadside unit provided along the ETC lane, and pays a toll of the toll road. Additionally, the hardware configuration of the company vehicle 2 is not limited to the one illustrated in FIG. 3.

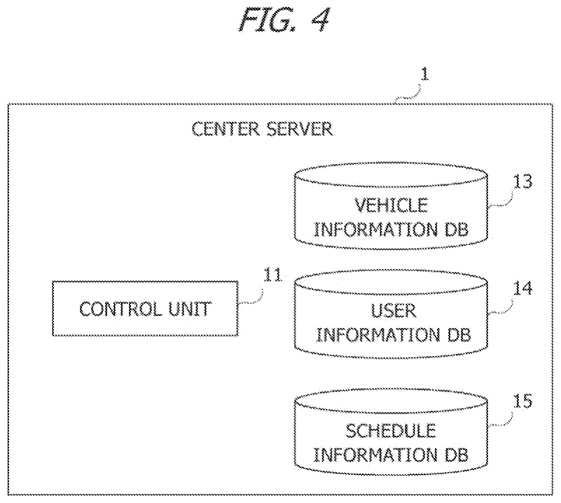

FIG. 4 is a diagram illustrating an example of a functional configuration of the central server 1. As the functional configuration, the center server 1 includes a control unit 11, a vehicle information database (DB) 13, a user information DB 14, and a schedule information DB 15. These functional structural elements are implemented by the CPU 101 of the center server 1 executing a control program of the company vehicle rental system 100, for example.

The control unit 11 controls rental of the company vehicle 2. Specifically, the control unit 11 receives a rental request for the company vehicle from the user terminal 3. User identification information, the purpose of use, and search conditions are also received from the user terminal 3 together with the rental request. The search conditions include a rental period, a departure point, and a return point, for example. The purpose of use may be business activity or personal use, for example.

After receiving the rental request, the control unit 11 refers to the vehicle information DB 13 and the schedule information DB 15 described later, and extracts a company vehicle 2 that satisfies the search conditions. For example, a company vehicle 2 that satisfies the search conditions is a vehicle for which a schedule is not set in the rental period included in the search conditions and that is located at the departure point included in the search conditions at a time of start of the rental period included in the search conditions. The control unit 11 transmits information about the company vehicle 2 that satisfies the search conditions to the user terminal 3 that is the transmission source of the rental request. Information about the company vehicle 2 that is transmitted to the user terminal 3 is information about a body type of the vehicle and options that are mounted, for example.

The control unit 11 receives a reservation request from the user terminal 3. Rental information including information indicating the company vehicle 2 that is a reservation target, the rental period, the departure point and the return point is also received together with the reservation request. Additionally, in the case where the user is an employee, information indicating whether the purpose of use is business activity or personal use is also received with the reservation request. The control unit 11 registers the received rental information in the schedule information DB 15, and a rental reservation for the company vehicle 2 is thereby fixed. Then, the control unit 11 notifies the user terminal 3 that the rental reservation for the company vehicle 2 is fixed. Information about the schedule for which the reservation is fixed is also transmitted to the user terminal 3 together with the notification that the reservation is fixed. Information about the schedule for which the reservation is fixed includes the rental period, the departure point, the return point, and information about the company vehicle 2 that is the rental target, for example. Information about the company vehicle 2 that is the rental target includes information presented on a license plate and information about the body type of the vehicle, for example.

Next, the control unit 11 manages, in relation to rental of the company vehicle 2, use settings regarding use of the options mounted in the company vehicle 2. Specifically, when a time that is a predetermined time before the rental start time of the company vehicle 2 is reached, the control unit 11 transmits use-settings information according to the purpose of use to the data communication device 20 of the company vehicle 2. When the use-settings information is received from the center server 1, the data communication. device 20 performs setting of each device according to the use-settings information.

The vehicle information DB 13, the user information DB 14, and the schedule information DB 15 are created in a predetermined area in the external storage device 103 of the center server 1. The vehicle information DB 13 stores information about the company vehicle 2. The schedule information DB 15 stores information about schedule of rental of the company vehicle 2. Details of information stored in the vehicle information DB 13 and the schedule information DB 15 will be given later.

The user information DB 14 stores information about a user who is registered in the company vehicle rental system 100. Information stored in the user information DB 14 includes identification information, a name, an address, contact information and the like of the user, for example. Additionally, users who can rent the company vehicle 2 are not limited to employees of the organization managing the company vehicle 2, and may include general users. Additionally, the functional configuration of the center server 1 illustrated in FIG. 4 is merely an example and the functional configuration is not limited to the one illustrated in FIG. 4.

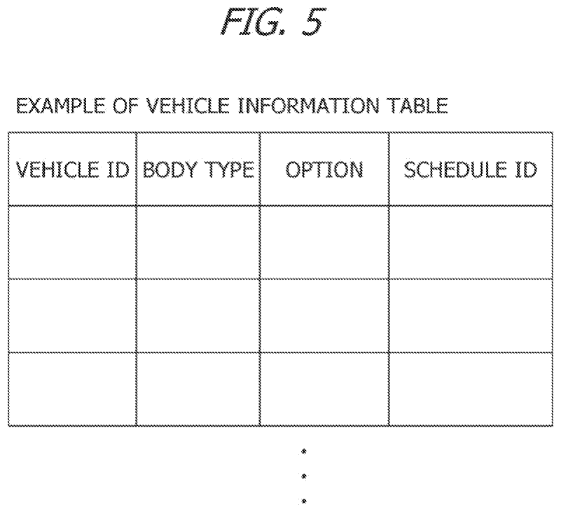

FIG. 5 is an example of a vehicle information table. The vehicle information table is a table that is stored in the vehicle jnformation DB 13. The vehicle information table includes the following fields: vehicle ID, body type, option, and schedule ID. Identification information of the company vehicle 2 is stored is the field “vehicle ID”. Information indicating the body type of the company vehicle 2 is stored in the field “body type”. The body type of the company vehicle 2 is a sedan or a wagon, for example. Information indicating options mounted. in the company vehicle 2 is stored in the field “option”.

Identification information of a schedule that is set for the company vehicle 2 and that is not yet carried out is stored in the field “schedule ID”. Values are set in advance in the fields “vehicle ID”, “body type” and “option”. The value in the field “schedule ID” is updated by the control unit 11 when a schedule is set for the company vehicle 2 and when the schedule of the company vehicle 2 is completed, for example. Additionally, the data structure of the vehicle information DB 13 is not limited to the one illustrated in FIG. 5.

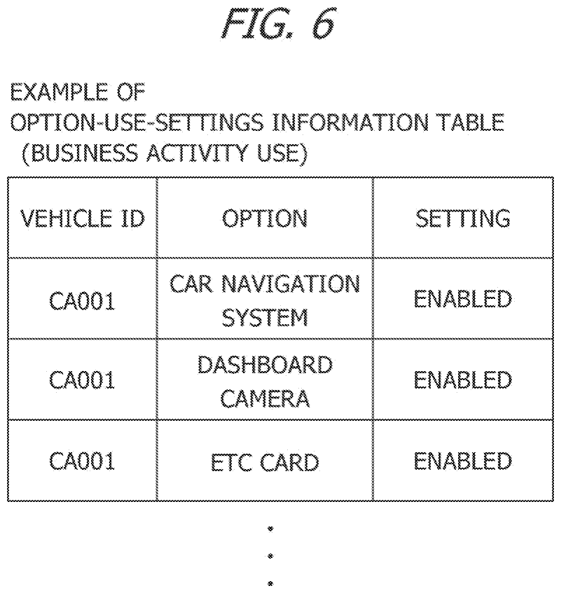

FIG. 6 is an example of an option-use-settings information table for when the purpose of use is business activity. The option-use-settings information table is a table holding use settings of options mounted in the company vehicle 2. The option-use-settings information table is stored in the vehicle information DB 13. The option-use-settings information table includes the following fields: vehicle ID, option, and setting.

The identification information of the company vehicle 2 is stored in the field “vehicle ID”. Information indicating an optional device is stored in the field “option”. Information indicating an optional device may be identification information, a code or the like, for example. In FIG. 6, for the sake of convenience, terms “car navigation system”, “dashboard camera” and “ETC card” are stored in the fields of “option” to indicate the types of options.

Settings are stored in the field “setting”. For example, “enabled” or “disabled” is stored as the settings. In the case where “enabled” is stored in the field “setting”, the corresponding option is enabled and the option operates when the company vehicle 2 operates.

In the case where “disabled” is stored in the field “setting”, the corresponding option is disabled and the option does not operate even when the company vehicle 2 operates.

In the example illustrated in FIG. 6, in the case of use of a company vehicle 2 whose vehicle ID is “CA001” for business activity, the car navigation system, the dashboard camera, and the ETC card are all enabled, and it is indicated that these options operate when the company vehicle 2 operates.

Additionally, information to be stored in the field “setting” is not limited to “enabled” and “disabled”. For example, “enabled” or “disabled” may be set for each function of each option, or a storage location of data of a recorded image or recorded sound may be specified.

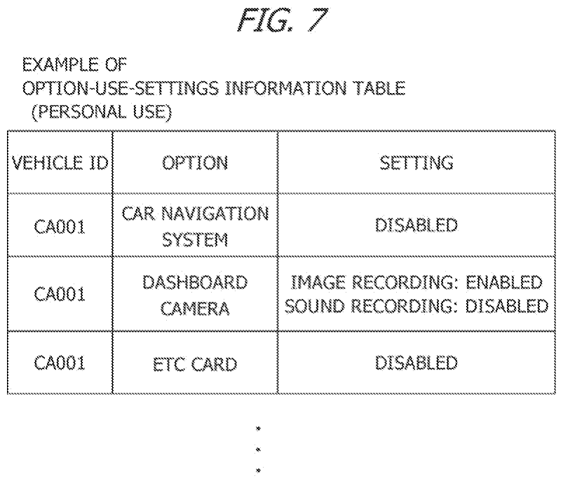

FIG. 7 is an example of the option-use-settings information table for when the purpose of use is personal use. The option-use-settings information table illustrated in FIG. 7 is also stored in the vehicle information DB 13. Furthermore, the fields included is the option-use-settings information table illustrated in FIG. 7 are the same as those of the option-use-settings information table illustrated in FIG. 6.

In FIG. 7, the car navigation system is set to “disabled”. In relation to the dashboard camera, “image recording: enabled” and “sound recording: disabled” are set. The ETC card is set to “disabled”. Additionally, in the case where the sound. recording of the dashboard camera is separated between outside and inside of the company vehicle 2, “enabled” or “disabled” may be set for each of sound recording outside the company vehicle 2 and sound recording inside the company vehicle 2.

Additionally, in another example of the option-use-settings information for when the purpose of use is personal use, the car navigation system, the dashboard camera, and the ETC card may all be “disabled”, for example. In relation to the dashboard camera, in the case where the purpose of use is personal use, a data storage area may be specified in the field of “setting” in the option-use-settings information table so that data of recorded image and recorded sound of the camera is stored in a different storage area than in the case of business activity. Furthermore, in the case where the purpose of use is personal use and data is to be saved in a storage area different from that for business activity, a secure area that is protected by a password or the like may be used as the storage area, for example. The password is notified only to the user of the company vehicle 2, for example. A storage area in the dashboard camera where data of recorded image and recorded sound of the camera is stored when the purpose of use is business activity is an example of “first storage”. A storage area in the dashboard camera where data of recorded image and recorded sound of the camera is stored when the purpose of use is personal use is an example of “second storage”.

Moreover, the car navigation system may be set to “enabled” even when the purpose of use is personal use. Furthermore, settings of “home” in the car navigation system may be changed between when the purpose of use is business activity and when the purpose of use is personal use. For example, in the case where the purpose of use is business activity, an address of one of hubs of the organization managing the company vehicle 2 may be set as “home” in the car navigation system. For example, in the case where the purpose of use is personal use, the address of the home of a user may be set as “home” in the car navigation system. Which address is set as “home” in the car navigation system is also set in the field of “setting” in the option-use-settings information table.

For example, the address of the hub of the organization managing the company vehicle 2 that is to be used as “home” by the car navigation system may be described in the field of “setting” in the option-use-settings information table. For example, in relation to the address of the home of a user that is to be used as “home” by the car navigation system, “use home address of user” may be described in the field of “setting” in the option use-settings information table, and the control unit 11 may read out the home address of the user from the user information DB 14 and transmit the same to the data communication device 20.

Additionally, the option-use-settings information tables illustrated in FIGS. 6 and 7 are merely examples and not restrictive. The option-use-settings information table, as illustrated in FIG. 6, for when the purpose of use is business activity is an example of “first use-settings information”. The option-use-settings information table, as illustrated in FIG. 7 for when the purpose of use is personal use is an example of “second use-settings information”. The option-use-settings information tables illustrated in FIGS. 6 and 7 are set in advance by the predetermined organization managing the company vehicle 2.

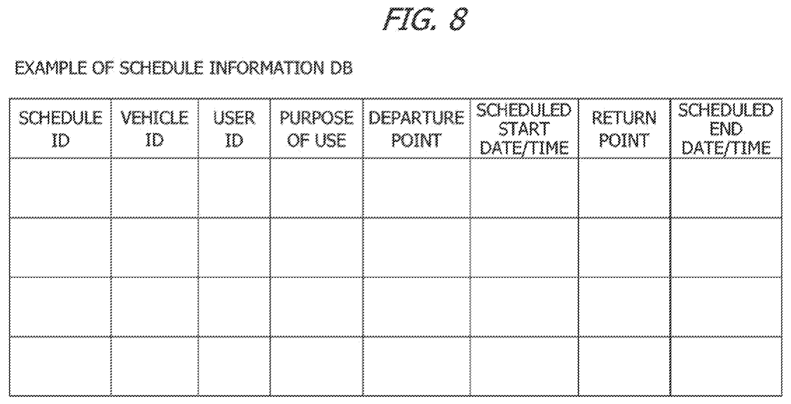

FIG. 8 is an example of the data structure of the schedule information DB 15. A record in the schedule information DB 15 includes the following fields: schedule ID, vehicle ID, user ID, purpose of use, departure point, scheduled start date/time, return point, and scheduled end date/time.

Identification information of a schedule is stored in the field “schedule ID”. Identification information of a company vehicle 2 to which the schedule is assigned is stored in the field “vehicle ID”. User identification information of a user who made reservation for the schedule is stored in the field “user ID”.

Information indicating the type of purpose of use is stored in the field “purpose of use”. The purpose of use may be business activity or personal use, for example.

Information pieces indicating the departure point and the return point, respectively, are stored in the corresponding fields “departure point” and “return point”. As the departure point or the return point, a hub of the company using the company vehicle rental system 100 and other than the hub of the company using the company vehicle rental system 100, such as a parking lot, may be cited, for example. The hub of the company using the company vehicle rental system 100 may be a head office, a branch office, a shop, a sales office or the like, for example. Information indicating the departure point or the return point is a code, for example.

Information pieces indicating the scheduled start date/time and the scheduled end date/time of the rental period, respectively, are stored in the corresponding fields “scheduled start date/time” and “scheduled end date/time”.

The record in the schedule information DE 15 is created by the control unit 11 when a reservation request for rental of the company vehicle 2 is received, for example. The identification information. of the schedule in the field “schedule ID” is assigned by the control unit 11. The identification information. of the company vehicle 2 in the field “vehicle ID” is the identification information of the company vehicle 2 that is selected by the user. The user identification information in the field “user ID” is the user identification information of the user who made the reservation. Information pieces included in the rental information that is received together with the reservation request are stored for “purpose of use”, “departure point”, “scheduled start date/time”, “refuse point”, and “scheduled end date/time”. Additionally, the data structure of the schedule information DB 15 is not limited to the one illustrated in FIG. 8.

### Flow of Process

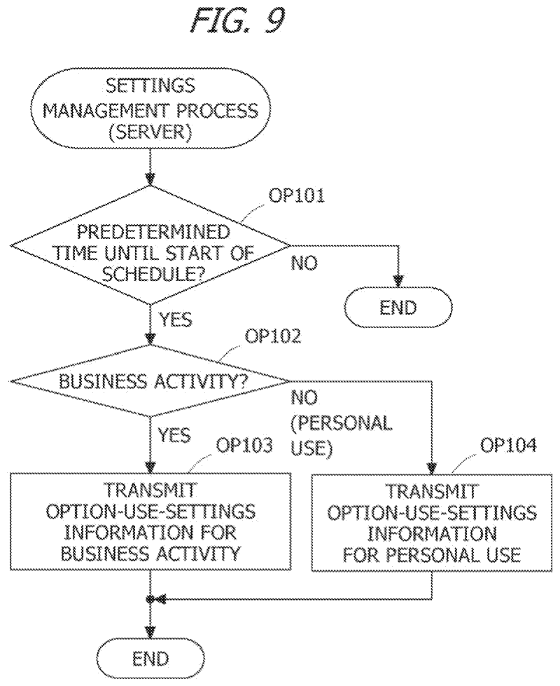

FIG. 9 is an example of a flowchart of a settings management process by the center server 1. The settings management process is a process of performing setting regarding options mounted in a company vehicle 2 according to a schedule of rental of the company vehicle 2. The process illustrated in FIG. 9 is repeatedly performed during operation of the center server 1. The performer of the process illustrated in FIG. 9 is the CPU 101 of the center server 1, but a functional structural element will be described to be the performer for the sake of convenience. The same applies to flowcharts of subsequent processes by the center server 1.

In OP101, the control unit 11 determines whether or not a time that is a predetermined time before a scheduled start time of a schedule is reached. The predetermined time is one hour before, 30 minutes before or 5 minutes before, for example. In the case where the time that is the predetermined time before the scheduled start time of the schedule is reached (OP101: YES), the process proceeds to OP102. In the case where the time that is the predetermined time before the scheduled start time of the schedule is not yet reached. (OP101: NO), the process illustrated in FIG. 9 is ended.

In OP102, the control unit 11 determines whether the purpose of use of the target schedule is business activity or personal use. In the case where the purpose of use of the target schedule is business activity (OP102: YES), the process proceeds to OP103. In the case where the purpose of use of the target schedule is personal use (OP102: NO), the process proceeds to OP104.

In OP103, the control unit 11 reads out the option-use-settings information corresponding to the vehicle ID of the company vehicle 2 in question from the option-use-settings information table, in the vehicle information DB 13, for when the purpose of use is business activity, and transmits the option-use-settings information to the data communication device 20 of the company vehicle 2. The process illustrated in FIG. 9 is then ended.

In OP104, the control unit 11 reads out the option-use-settings information corresponding to the vehicle ID of the company vehicle 2 in question from the option-use-settings information table, in the vehicle information DB 13, for when the purpose of use is personal use, and transmits the option-use-settings information to the data communication device 20 of the company vehicle 2. The process illustrated in FIG. 9 is then ended.

When the option-use-settings information is received from the center server 1, the data communication device 20 of the company vehicle 2 performs setting of the options that are mounted, according to contents of the information.

### Operation and Effects of First Embodiment

In the first embodiment, contents of the use-settings information for the options mounted in the company vehicle 2 are changed depending on whether the purpose of use of the company vehicle 2 is business activity or personal use. Accordingly, usable function may be changed for each option according to the purpose of use of the company vehicle 2.

In the first embodiment, use of functions of options are more restricted when the company vehicle 2 is used for personal use than when the company vehicle 2 is used for business activity, and thus, privacy of the user nay be protected is the case of personal use. For example, in the case of using the company vehicle 2 for personal use, privacy is protected by disabling recording of sound by the dashboard camera or by saving data of recorded sound and recorded images in a storage area that is protected by a password.

### Other Embodiments

The embodiment described above is an example, and the present disclosure may be changed and carried out as appropriate without departing from the gist of the present disclosure.

In the first embodiment, a description is given assuming that the company vehicle rental system 100 is a system that performs management for one company, but the company vehicle rental system 100 may alternatively be shared by a plurality of organizations. This is enabled by preparing the vehicle information DB 13, the user information DB 14, and the schedule information DB 15 for each organization, for example.

In the first embodment, the center server 1 manages the option-use-settings information of each. company vehicle 2, but instead of the center server I, the data communication device 20 mounted in the company vehicle 2 may manage the option-use-settings information of the corresponding company vehicle 2. In this case, for example, the data communication device 20 may acquire, from the center server 1, the schedule information of the company vehicle 2 where the data communication device 20 itself is mounted, and perform the process in FIG. 9.

The processes and means described is the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

1. An information processing apparatus comprising a controller configured to:
acquire, in relation to a first vehicle associated with a predetermined organization, information about a schedule including a purpose of use,
output, in a case where the purpose of use of the first vehicle is business activity, first use-settings information indicating settings regarding use of one or more options mounted in the first vehicle, and
output, in a case where the purpose of use of the first vehicle is personal use, second use-settings information indicating settings regarding use of the one or more options mounted in the first vehicle.

2. The information processing apparatus according to claim 1, wherein, in a case where a time that is a predetermined time before a start time of the schedule is reached, the controller is configured to output, to the first vehicle, the first or the second use-settings information about the one or more options in the first vehicle.

3. The information processing apparatus according to claim 1, wherein
the first use-settings information indicates that all of the one or more options are usable, and
the second use-settings information indicates that use of at least one of the one or more options is restricted.

4. The information processing apparatus according to claim 3, wherein
the first use-settings information includes enabling an ETC(Electronic Toll Collection) card that is inserted in an ETC onboard device that is one of the one or more options, and
the second use-settings information includes disabling the ETC card.

5. The information processing apparatus according to claim 3, wherein
the first use-settings information includes, in relation to a dashboard camera that is one of the one or more options, recording a captured image of surroundings of the first vehicle, and
the second use-settings information includes, in relation to the dashboard camera, not recording the captured image of the surroundings of the first vehicle.

6. The information processing apparatus according to claim 3, wherein
the first use-settings information includes, in relation to a dashboard camera that is at least one of the one or more options, recording sound inside the first vehicle, and
the second use-settings information includes, in relation to the dashboard camera, not recording the sound inside the first vehicle.

7. The information processing apparatus according to claim 3, wherein
the first use-settings information includes, in relation to a dashboard camera that is at least one of the one or more options, saving, in a first storage, data of a captured image of surroundings of the first vehicle that is recorded or data of sound inside the first vehicle that is recorded, and
the second use-settings information includes, in relation to the dashboard camera, saving, in a second storage, data of a captured image of surroundings of the first vehicle that is recorded or data of sound inside the first vehicle that is recorded.

8. The information processing apparatus according to claim 7, wherein the second storage is protected by a password that is notified to a user of the first vehicle.

9. The information processing apparatus according to claim 1, wherein
the first use-settings information includes, in relation to a car navigation system that is at least one of the one or more options, setting an address that is associated with the predetermined organization as home information, and
the second use-settings information includes, in relation to the car navigation system, setting an address that is associated with a user of the first vehicle as the home information.

10. The information processing apparatus according to claim 1, wherein the information processing apparatus is an onboard device that is mounted in the first vehicle.

11. The information processing apparatus according to claim 1, wherein the information processing apparatus is a server that is capable of communicating with an onboard device that is mounted in the first vehicle.

12. A method comprising:
acquiring, in relation to a first vehicle associated with a predetermined organization, information about a schedule including a purpose of use,
outputting, in a case where the purpose of use of the first vehicle is business activity, first use-settings information indicating settings regarding use of one or more options mounted in the first vehicle, and
outputting, in a case where the purpose of use of the first vehicle is personal use, second use-settings information indicating settings regarding use of the one or more options mounted in the first vehicle.

13. The method according to claim 12, wherein, in a case where a time that is a predetermined time before a start time of the schedule is reached, the first or the second use-settings information about the one or more options in the first vehicle is output to the first vehicle.

14. The method according to claim 12, wherein
the first use-settings information indicates that all of the one or more options are usable, and
the second use-settings information indicates that use of at least one of the one or more options is restricted.

15. The method according to claim 14, wherein
the first use-settings information includes enabling an ETC(Electronic Toll Collection) card that is inserted in an ETC onboard device that is one of the one or more options, and
the second use-settings information includes disabling the ETC card.

16. The method according to claim 14, wherein
the first use-settings information includes, in relation to a dashboard camera that is one of the one or more options, recording a captured image of surroundings of the first vehicle, and
the second use-settings information includes, in relation to the dashboard camera, not recording the captured image of the surroundings of the first vehicle.

17. The method according to claim 14, wherein
the first use-settings information includes, in relation to a dashboard camera that is at least one of the one or more options, recording sound inside the first vehicle, and
the second use-settings information includes, in relation to the dashboard camera, not recording the sound inside the first vehicle.

18. The method according to claim 14, wherein
the first use-settings information includes, in relation to a dashboard camera that is at least one of the one or more options, saving, in a first storage, data of a captured image of surroundings of the first vehicle that is recorded or data of sound inside the first vehicle that is recorded, and
the second use-settings information includes, in relation to the dashboard camera, saving, in a second storage, data of a captured image of surroundings of the first vehicle that is recorded or data of sound inside the first vehicle that is recorded.

19. The method according to claim 18, wherein the second storage is protected by a password that is notified to a user of the first vehicle.

20. The method according to claim 12, wherein
the first use-settings information includes, in relation to a car navigation system that is at least one of the one or more options, setting an address that is associated with the predetermined organization as home information, and
the second use-settings information includes, in relation to the car navigation system, setting an address that is associated with a user of the first vehicle as the home information.
